(19) United States
(12) Patent Application Publication
(10) Pub. No.: US 2025/0010170 A1
(43) Pub. Date: Jan. 9, 2025

(54) SYSTEM AND METHODS FOR DETECTING AND PREDICTING BOWLING LANE ERRORS

(71) Applicants: Inhyuck Kim, Oakville (CA); Yoo Jung Jhon, Richmond Hill (CA); Inun Kim, Gunpo-si (KR)

(72) Inventors: Inhyuck Kim, Oakville (CA); Yoo Jung Jhon, Richmond Hill (CA); Inun Kim, Gunpo-si (KR)

(21) Appl. No.: 18/763,643

(22) Filed: Jul. 3, 2024

Related U.S. Application Data
(60) Provisional application No. 63/525,048, filed on Jul. 5, 2023.

(51) Int. Cl. A63D 5/04; A63D 5/09; G06V 20/40

(52) U.S. Cl. CPC A63D 5/04; A63D 5/09; G06V 20/42

(57) ABSTRACT

A computer-implemented method, comprising obtaining, in real-time, video data of a video depicting at least a portion of a bowling pinsetter, detecting at least one of a bowling pin, a distributor, or a pin station in a video frame of the video, determining a class associated with the detected at least one bowling pin, distributor, or pin station, the class being one of a set of defined classes for identifying an error state of the bowling pinsetter, and in response to determining that the class is indicative of pinsetter error, activating a stopper component for temporarily pausing operation of the bowling pinsetter.

### CROSS-REFERENCE TO RELATED APPLICATION

The present application claims the benefit of priority to U.S. Provisional Patent Application No. 63/525,048 filed on Jul. 5, 2023, the contents of which are incorporated herein by reference.

### TECHNICAL FIELD

The present disclosure relates to bowling technology and, more particularly, to a system and methods for controlling operation of pinsetters in bowling alleys.

### BACKGROUND

Existing systems for monitoring operation of bowling alleys rely primarily on manual inspections and reactive troubleshooting. An employee or technician would typically attend to resolving a mechanical issue with a bowling lane after it is reported by a customer. Such monitoring systems have limited capacity for error prevention and proactive maintenance. While the use of advanced sensors may facilitate collection of data for error detection, the high costs of installing such sensors make them generally inaccessible.

### BRIEF DESCRIPTION OF THE DRAWINGS

Implementations are described in detail below, with reference to the following drawings:

FIG. 1 is a schematic diagram illustrating an operating environment of an example embodiment;

FIG. 2A is high-level schematic diagram of a computing device;

FIG. 2B shows a simplified organization of software components stored in a memory of the computing device of FIG. 2A;

FIG. 3 shows, in flowchart form, an example method for controlling a bowling pinsetter;

FIG. 4 shows, in flowchart form, another example method for controlling a bowling pinsetter; and

FIG. 5 shows, in flowchart form, an example method for generating maintenance schedules for bowling pinsetters.

Like reference numerals are used in the drawings to denote like elements and features.

### DETAILED DESCRIPTION OF EMBODIMENTS

In an aspect, a computer-implemented method is disclosed. The method may include: obtaining, in real-time, video data of a video depicting at least a portion of a bowling pinsetter; detecting at least one of a bowling pin, a distributor, or a pin station in a video frame of the video; determining a class associated with the detected at least one bowling pin, distributor, or pin station, the class being one of a set of defined classes for identifying an error state of the bowling pinsetter; and in response to determining that the class is indicative of pinsetter error, activating a stopper component for temporarily pausing operation of the bowling pinsetter.

In some implementations, detecting the at least one of a bowling pin, a distributor, or pin station in the video frame may include performing object recognition based on frame data of the video frame using a trained machine learning model.

In some implementations, the machine learning model may be trained using images that are classified as either pinsetter error or pinsetter operational, the images depicting at least one of bowling pins, distributors, or pin stations.

In some implementations, determining the class may include obtaining, for each of one or more classes of the set, a probability value representing a likelihood that the video frame is associated with the class.

In some implementations, the error state may comprise a pin jam in a distributor of the bowling pinsetter.

In some implementations, the method may further include: detecting, in the video frame of the video, at least one pinsetter component from: a pin elevator; a bin assembly; a ball lift; a distributor; a sweep; a table motor; a sweep motor; a shark assembly; feed lanes; an ejector flap; a retaining bow; turn wedges; a setting table; pin holders; or pin detector plates; and determining a class associated with the video frame based on classes associated with detected pinsetter components.

In some implementations, the method may further include in response to determining that the class is indicative of a potential pinsetter error: generating an error notification message indicating the potential pinsetter error; and transmitting, to a computing device associated with an administrator of the bowling pinsetter, the error notification message.

In some implementations, the method may further include in response to determining that the class is indicative of pinsetter error: obtaining video data of a segment of the video corresponding to a time period preceding detection of the pinsetter error; and uploading, to a shared data store, the video data of the segment.

In some implementations, determining the class may include identifying one of the set of classes that is associated with a highest probability value.

In some implementations, the video data of the video may depict a top view of the distributor.

In another aspect, a pinsetter control system is disclosed. The system includes a processor and a memory coupled to the processor. The memory stores computer-executable instructions that, when executed by the processor, may cause the processor to: obtain, in real-time, video data of a video depicting at least a portion of a bowling pinsetter; detect at least one of a bowling pin, a distributor, or a pin station in a video frame of the video; determine a class associated with the detected at least one bowling pin, distributor, or pin station, the class being one of a set of defined classes for identifying an error state of the bowling pinsetter; and in response to determining that the class is indicative of pinsetter error, activate a stopper component for temporarily pausing operation of the bowling pinsetter.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example implementations of the present application are not limited to any particular operating system, system architecture, mobile device architecture, server architecture, or computer programming language.

A monitoring system for bowling pinsetters is disclosed. The monitoring system includes a network of a plurality of cameras that are installed in a bowling alley. In at least some implementations, the cameras may be installed above the pinsetters such that a field of view of each camera includes at least one of the pinsetters. The cameras are configured to continuously capture video footage of the pinsetter area. By analyzing the captured videos in real-time, the monitoring system can detect errors (or failures, malfunctions, breakdowns, or other mechanical issues) associated with the pinsetters and identify potential errors/issues which may occur during pin-setting operation. In particular, the monitoring system may be configured to detect and track specific objects, such as bowling pins or mechanical components within the pinsetter machinery, in video frames of the captured video footage and their current state (e.g., position, orientation, etc.) to assess likelihood of errors or malfunctions.

In some implementations, the monitoring system may incorporate a stopper (switch) component. When an error associated with a pinsetter is detected by the monitoring system, the stopper may be activated to pause operation of the pinsetter temporarily. This may ensure safe and proper functioning of the pinsetter in the event of a mechanical issue (e.g., pin jam). In particular, further damage or complications associated with malfunctioning pinsetters may be prevented.

The monitoring system may generate error alerts in real-time. A message indicating a detected error (or a potential error) may be generated by the monitoring system and transmitted to an administrator. For example, a notification message identifying a detected error may be provided, in real-time, as a push notification for an administrator in an app associated with the monitoring system.

Additionally, or alternatively, the monitoring system may be configured to obtain video data of video footage depicting the pinsetter area immediately prior to and/or following detection of an error (or identification of potential error). For example, the monitoring system may capture video footage of a predefined length (e.g., 2-3 minutes) leading up to an error detection event. The captured video may be automatically uploaded to a shared data store (e.g., a cloud-based database), which may be accessed by authorized entities such as employees, technicians, etc.

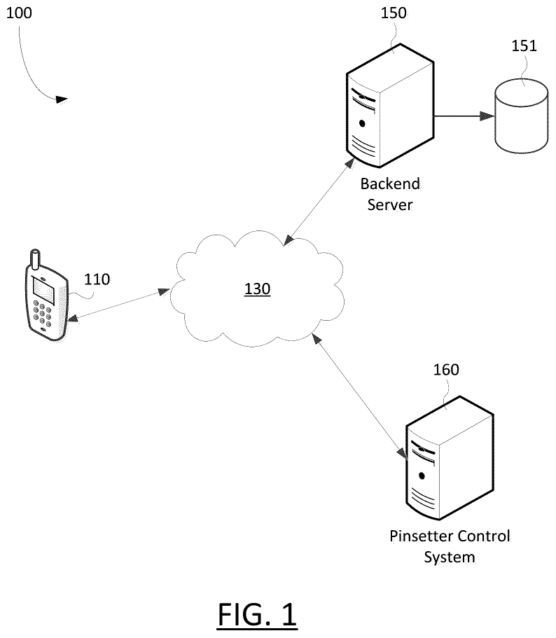

Reference is first made to FIG. 1, which is a schematic diagram illustrating an exemplary computing environment 100 consistent with certain disclosed implementations. As shown in FIG. 1, the computing environment 100 may include one or more client devices 110, a backend server 150, a database 151 associated with the backend server 150, a pinsetter control system 160, and a communications network 130 connecting one or more of the components of computing environment 100.

The backend server 150 (which may also be referred to as a server computer system) and the client devices 110 communicate via the network 130. In at least some implementations, the client device 110 is a computing device. The client device 110 may take a variety of forms including, for example, a mobile communication device such as a smartphone, a tablet computer, a wearable computer such as a head-mounted display or smartwatch, a laptop or desktop computer, or a computing device of another type. The client device 110 may store software instructions that enable the client device to establish communications with the backend server 150 and the pinsetter control system 160.

The backend server 150 may be a server implementing an application (e.g., a mobile app) for managing bowling alley operation. The client entity may be a user, such as an administrator or a technician, of the application. In at least some implementations, the application may allow users to access and review data for troubleshooting errors in pinsetter or ball return mechanisms of bowling lanes. For example, a bowling alley technician may use the application to view live or saved videos depicting one or more pinsetters. By reviewing video footage, the technician can gain valuable insight into events preceding an error (or potential error).

The database 151 comprises a cloud-based data store. The database 151 stores various data collected from at least one pinsetter control system 160. In at least some implementations, videos captured using cameras of a pinsetter control system 160 may be selectively uploaded and stored in the database 151. For example, when a pinsetter error is detected, video footage depicting the pinsetter immediately prior to and/or following the time of detection may be automatically uploaded to the database 151. The uploaded videos may be stored in association with an identifier of the pinsetter, bowling lane, and/or bowling alley. The database 151 may store additional information such as historical maintenance and repair log data, error incidence data, error types, and the like.

The computing environment 100 includes at least one pinsetter control system 160. A pinsetter control system 160 is a computer system that is configured to control operation of one or more bowling pinsetters. The pinsetter control system 160 includes one or more cameras for capturing videos depicting at least a portion of a pinsetter, including components within the pinsetter machinery. The cameras may be installed adjacent to and/or above the pinsetter, and are configured to continuously capture video footage of the pinsetter area.

The pinsetter control system 160 obtains video frame data of videos captured by the cameras and performs analysis of the video frame data. As will be described in greater detail below, the pinsetter control system performs object detection based on the video frame data for detecting objects (e.g., bowling pins, distributor, etc.) and classifying the detected objects to determine whether they are indicative of pinsetter error. By performing the analysis in real-time, potential errors of a pinsetter may be detected. For example, video analysis of a current setup of bowling pins in pin stations may indicate that an error is likely to occur. Based on the analysis, remedial measures may be taken to prevent or mitigate the effects of the predicted error.

The pinsetter control system 160 also includes components for enforcing error determinations on operation of a pinsetter. In at least some implementations, the pinsetter control system 160 includes a stopper component. The stopper may be a mechanical component of the pinsetter that is configured for data communication. For example, the stopper may be installed on the pinsetter and configured to receive messages (e.g., instructions for execution) via a wireless communication protocol, such as Zigbee™. When a pinsetter error (or potential error) is detected by the pinsetter control system 160, the stopper component may be activated for temporarily pausing operation of an affected pinsetter. In particular, a server computer associated with the pinsetter control system 160 may provide instructions, via wireless communication, to the stopper component to pause operation of the pinsetter.

In some implementations, the cameras may be standalone devices that are configured to perform various functions of the pinsetter control system 160. That is, the cameras may perform, among other operations: capture of video footage depicting pinsetters; video frame analysis; object detection; and upload of relevant video footage (and/or segments thereof) to a data store, such as a cloud-based database.

The client device 110, the backend server 150, and the pinsetter control system 160 may be in geographically disparate locations. Put differently, the client device 110 may be remote from at least one of the backend server 150 and the pinsetter control system 160. As described above, each of the client device 110, the backend server 150, and the pinsetter control system 160 may be a computer system.

The network 130 is a computer network. In some implementations, the network 130 may be an internetwork such as may be formed of one or more interconnected computer networks. For example, the network 130 may be or may include an Ethernet network, an asynchronous transfer mode (ATM) network, a wireless network, or the like. The network 130 may, in some implementations, include a plurality of distinct networks. For example, communications between certain of the computer systems may be over a private network whereas communications between other of the computer systems may be over a public network, such as the Internet.

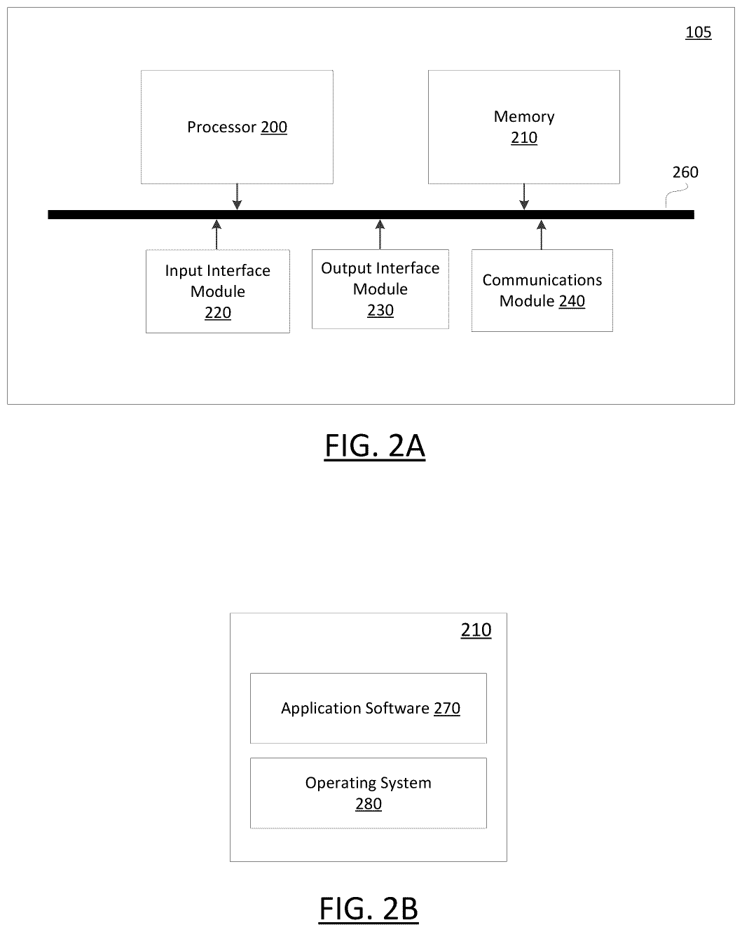

FIG. 2A is a high-level operation diagram of an example computing device 105. In at least some implementations, the example computing device 105 may be exemplary of one or more of the client devices 110, the backend server 150, and the pinsetter control system 160. The example computing device 105 includes a variety of modules. For example, as illustrated, the example computing device 105, may include a processor 200, a memory 210, an input interface module 220, an output interface module 230, multimedia processing module 240 and a communications module 250. As illustrated, the foregoing example modules of the example computing device 105 are in communication over a bus 260.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some implementations, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 230 may be integrated with an output device. For example, the output interface module 230 may be integrated with one of the aforementioned example output devices.

The communications module 250 allows the example computing device 105 to communicate with other electronic devices and/or various communications networks. For example, the communications module 250 may allow the example computing device 105 to send or receive communications signals. Communications signals may be sent or received according to one or more protocols or according to one or more standards. For example, the communications module 250 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like.

Additionally, or alternatively, the communications module 250 may allow the example computing device 105 to communicate using near-field communication (NFC), via Wi-Fi™, using Bluetooth™ or via some combination of one or more networks or protocols. Contactless payments may be made using NFC. In some implementations, all or a portion of the communications module 250 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components include an operating system 280 and application software 270.

The operating system 280 is software. The operating system 280 allows the application software 270 to access the processor 200, the memory 210, the input interface module 220, the output interface module 230 and the communications module 250. The operating system 280 may be, for example, Apple iOS™, Google's Android™, Linux™, Microsoft Windows™, or the like.

The application software 270 adapts the example computing device 105, in combination with the operating system 280, to operate as a device performing particular functions. For example, the application software 270 may cooperate with the operating system 280 to adapt a suitable embodiment of the example computing device 105 to operate as the client device 110, the backend server 150, or the pinsetter control system 160.

While a single application software 270 is illustrated in FIG. 2B, in operation, the memory 210 may include more than one application software 270 and different application software 270 may perform different operations.

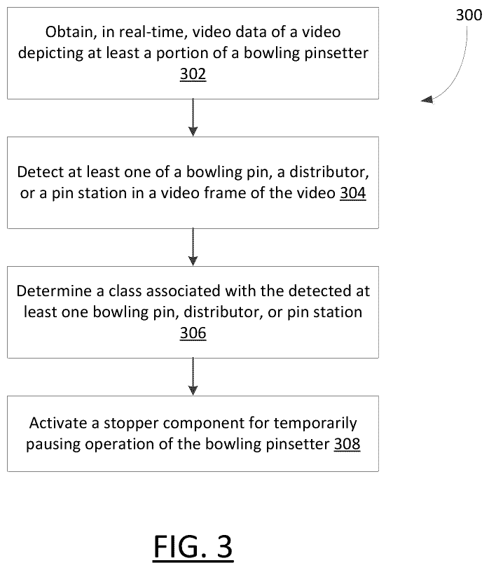

Reference is now made to FIG. 3 which shows, in flowchart form, an example method 300 for controlling a bowling pinsetter and components thereof. The operations of method 300 may be performed by a computer system for managing pinsetter operation, such as the pinsetter control system 160 of FIG. 1.

In operation 302, the computing system obtains, in real-time, video data of a video depicting at least a portion of a bowling pinsetter. The video data may be obtained from one or more cameras that are configured to capture video footage of a pinsetter area. For example, cameras that are installed adjacent to or above one or more pinsetters may generate the video data, and the computing system may retrieve the video data from the cameras in real-time. In at least some implementations, the video may depict a top view of a distributor of the pinsetter. In this view, the top portions of bowling pins, distributor, and/or pin stations may be visible in video frames of the video.

The computing system detects at least one of a bowling pin, a distributor, or a pin station in a video frame, in operation 304. The computing system performs object recognition based on frame data of the video frame using a trained machine learning model. The machine learning model may be trained using images that are classified as either pinsetter error or pinsetter operational. In some implementations, the object detection algorithm may be based on a deep learning technique, such as the “You Only Look Once” (YOLO) algorithm. Other techniques that leverage use of OpenCV, SSD, or CNN may be employed for the detection step. The YOLO network may be trained using annotated images of bowling pins, distributor, pin stations, etc. that are collected from the cameras and labeled/classified as pinsetter error or pinsetter operational. The trained model may be integrated into the computing system for detecting errors or potential errors associated with the pinsetter.

In operation 306, the computing system determines a class associated with the detected at least one bowling pin, distributor, or pin station. The error state may, for example, comprise a pin jam in a distributor of the bowling pinsetter. In some implementations, the computing system obtains, for each of one or more classes of the set, a probability value representing a likelihood that the video frame is associated with the class. The class of the detected object may be determined by identifying one of the set of classes that is associated with a highest probability value.

In response to determining that the class is indicative of pinsetter error, the computing system activates a stopper component for temporarily pausing operation of the bowling pinsetter, in operation 308.

In some implementations, the computing system may detect one or more other pinsetter components in the video frame data, using a suitable object detection algorithm/model. For example, the computing system may detect a component from: a pin elevator, a shark assembly, feed lanes, an ejector flap, a retaining bow, turn wedges, a setting table, pin holders, or pin detector plates. The computing system may be configured to determine a class associated with a video frame depicting a pinsetter based on the classes of all or a selected number of the detected objects in the video frame.

Where an actual pinsetter error is detected based on the video analysis, the computing system may obtain additional information for providing context about the detected error. In some implementations, in response to determining that the class is indicative of pinsetter error, the computing system obtains video data of a segment of the video corresponding to a time period immediately preceding and/or following detection of the pinsetter error. The video data of the segment may be uploaded to a shared data store that is accessible to authorized entities, such as an administrator, technicians, and the like.

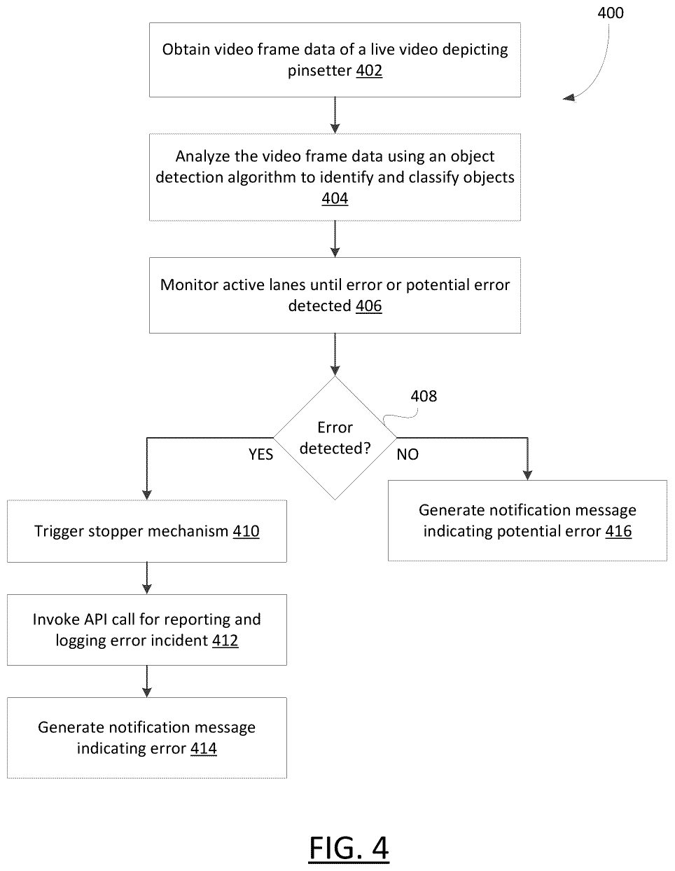

Reference is now made to FIG. 4 which shows, in flowchart form, another example method 400 for controlling a bowling pinsetter and components thereof. The operations of method 400 may be performed by a computer system for managing pinsetter operation, such as the pinsetter control system 160 of FIG. 1.

In operation 402, the computing system obtains video frame data of a live video depicting a bowling pinsetter. The video may be obtained, for example, from cameras that are disposed adjacent to or above the pinsetter to capture video footage of the pinsetter.

In operation 404, the computing system analyzes the video frame data using an object detection algorithm to identify and classify objects. The object detection algorithm may be based on a deep learning technique, such as YOLO described above. More particularly, the computing system uses a trained machine learning model to analyze video frames depicting objects, such as bowling pins, distributor, pin stations, etc., and predict probability values of which class (e.g., pinsetter error, pinsetter operational, or other suitably defined classes) the detected object(s) belongs to. The determination of whether a video frame depicts an error or potential error may be made based on the probability values associated with all or a selected number of the detected objects in the video frame. For example, if one or more detected objects in a video frame is associated with a probability value that exceeds a defined threshold, the computing system may determine that the video frame represents an error or potential error. The computing system monitors active lanes until error or potential error of the pinsetter is detected (operation 406).

Based on the probability values and comparison with defined thresholds, the computing system may determine that an actual error is detected. If an error is detected at operation 408, the computing system triggers a stopper mechanism (operation 410). The computing system invokes an API call for reporting and logging the error incident, in operation 412. A notification message may then be generated indicating the error (operation 414).

If, on the other hand, a potential error (and not an actual error) is detected, the computing system generates a notification message indicating the potential error, in operation 416. The generated error or potential error notification messages may be transmitted to a computing device associated with an administrator of the bowling pinsetter.

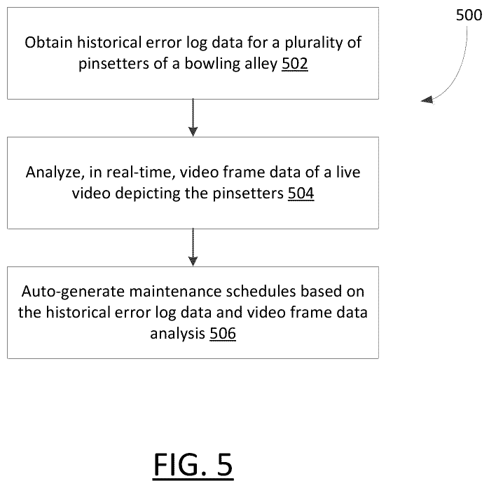

Reference is now made to FIG. 5 which shows, in flowchart form, an example method 500 for generating maintenance schedules for bowling pinsetters. The operations of method 500 may be performed by a computer system for managing pinsetter operation, such as the pinsetter control system 160 of FIG. 1.

In operation 502, the computing system obtains historical error log data for a plurality of pinsetters of a bowling alley. The historical error log data may comprise details about previous errors that have occurred in connection with the pinsetters, such as time of error, cause or likely cause of error, error type, resolution, and the like. In some implementations, the historical error log data may include video frame data of video segments corresponding to previously detected errors for the pinsetters. More particularly, one or more images/video frames depicting portions of a pinsetter at or around (i.e., immediately preceding or following) the times of occurrence of previous errors for the pinsetter may be stored as part of the historical error log data.

In operation 504, the computing system analyzes, in real-time, video frame data of a live video depicting the pinsetters. More particularly, the computing system performs object detection based on video frames of the live video to identify and classify one or more detected objects. In some implementations, the object detection may be performed using an algorithm that is, for example, based on a deep learning technique (e.g., YOLO).

In operation 506, the computing system auto-generates maintenance schedules for the pinsetters based on the historical error log data and the video frame data analysis. The historical error log data and video frame data analysis may provide information supporting determination of when and/or in what circumstances errors may be likely to occur. For example, the computing system may be configured to cross-reference image/video frame data corresponding to previously detected errors and current video frame data in order to identify or flag a potential error. The maintenance schedules may be generated in order to synchronize maintenance activities with likely occurrences of pinsetter errors.

More generally, the historical error log data and video frame data of real-time videos depicting a pinsetter may be used to identify patterns for error (or potential error) detection. In some implementations, video frame data corresponding to detected errors may be used to train a machine learning model for predicting errors or mechanical issues for pinsetters. For example, a YOLO network may be built and trained with annotated images to produce a trained model. Real-time video frame data may be put into the trained model to predict probability values of which class (e.g., pinsetter error, pinsetter operational, etc.) the detected objects in the video frames belong to. The computing system may process classification of video frames as indicating error (or potential error) based on the probability values.

The various implementations presented above are merely examples and are in no way meant to limit the scope of this application. Variations of the innovations described herein will be apparent to persons of ordinary skill in the art, such variations being within the intended scope of the present application. In particular, features from one or more of the above-described example implementations may be selected to create alternative example implementations including a sub-combination of features which may not be explicitly described above.

In addition, features from one or more of the above-described example implementations may be selected and combined to create alternative example implementations including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computer-implemented method, comprising:
obtaining, in real-time, video data of a video depicting at least a portion of a bowling pinsetter;
detecting at least one of a bowling pin, a distributor, or a pin station in a video frame of the video;
determining a class associated with the detected at least one bowling pin, distributor, or pin station, the class being one of a set of defined classes for identifying an error state of the bowling pinsetter; and
in response to determining that the class is indicative of pinsetter error, activating a stopper component for temporarily pausing operation of the bowling pinsetter.

2. The method of claim 1, wherein detecting the at least one of a bowling pin, a distributor, or pin station in the video frame comprises performing object recognition based on frame data of the video frame using a trained machine learning model.

3. The method of claim 2, wherein the machine learning model is trained using images that are classified as either pinsetter error or pinsetter operational, the images depicting at least one of bowling pins, distributors, or pin stations.

4. The method of claim 3, wherein determining the class comprises obtaining, for each of one or more classes of the set, a probability value representing a likelihood that the video frame is associated with the class.

5. The method of claim 1, wherein the error state comprises a pin jam in a distributor of the bowling pinsetter.

6. The method of claim 1, further comprising:
detecting, in the video frame of the video, at least one pinsetter component from: a pin elevator; a shark assembly; feed lanes; an ejector flap; a retaining bow; turn wedges; a setting table; pin holders; or pin detector plates; and
determining a class associated with the video frame based on classes associated with detected pinsetter components.

7. The method of claim 1, further comprising in response to determining that the class is indicative of a potential pinsetter error:
generating an error notification message indicating the potential pinsetter error; and
transmitting, to a computing device associated with an administrator of the bowling pinsetter, the error notification message.

8. The method of claim 1, further comprising in response to determining that the class is indicative of pinsetter error:
obtaining video data of a segment of the video corresponding to a time period preceding detection of the pinsetter error; and
uploading, to a shared data store, the video data of the segment.

9. The method of claim 1, wherein determining the class comprises identifying one of the set of classes that is associated with a highest probability value.

10. The method of claim 1, wherein the video data of the video depicts a top view of the distributor.

11. A pinsetter control system, comprising:
a processor;
a memory coupled to the processor, the memory storing computer-executable instructions that, when executed by the processor, are to cause the processor to:
obtain, in real-time, video data of a video depicting at least a portion of a bowling pinsetter;
detect at least one of a bowling pin, a distributor, or a pin station in a video frame of the video;
determine a class associated with the detected at least one bowling pin, distributor, or pin station, the class being one of a set of defined classes for identifying an error state of the bowling pinsetter; and
in response to determining that the class is indicative of pinsetter error, activate a stopper component for temporarily pausing operation of the bowling pinsetter.

12. The pinsetter control system of claim 11, wherein detecting the at least one of a bowling pin, a distributor, or pin station in the video frame comprises performing object recognition based on frame data of the video frame using a trained machine learning model.

13. The pinsetter control system of claim 12, wherein the machine learning model is trained using images that are classified as either pinsetter error or pinsetter operational, the images depicting at least one of bowling pins, distributors, or pin stations.

14. The pinsetter control system of claim 13, wherein determining the class comprises obtaining, for each of one or more classes of the set, a probability value representing a likelihood that the video frame is associated with the class.

15. The pinsetter control system of claim 11, wherein the error state comprises a pin jam in a distributor of the bowling pinsetter.

16. The pinsetter control system of claim 11, wherein the instructions, when executed, are to further cause the processor to:
detect, in the video frame of the video, at least one pinsetter component from: a pin elevator; a shark assembly; feed lanes; an ejector flap; a retaining bow; turn wedges; a setting table; pin holders; or pin detector plates; and
determine a class associated with the video frame based on classes associated with detected pinsetter components.

17. The pinsetter control system of claim 11, wherein the instructions, when executed, are to further cause the processor to in response to determining that the class is indicative of a potential pinsetter error:
generate an error notification message indicating the potential pinsetter error; and
transmit, to a computing device associated with an administrator of the bowling pinsetter, the error notification message.

18. The pinsetter control system of claim 11, wherein the instructions, when executed, are to further cause the processor to in response to determining that the class is indicative of pinsetter error:
obtain video data of a segment of the video corresponding to a time period preceding detection of the pinsetter error; and
upload, to a shared data store, the video data of the segment.

19. The pinsetter control system of claim 11, wherein determining the class comprises identifying one of the set of classes that is associated with a highest probability value.

20. The pinsetter control system of claim 11, wherein the video data of the video depicts a top view of the distributor.
